(19) United States
(12) Patent Application Publication
(10) Pub. No.: US 2007/0290548 A1
(43) Pub. Date: Dec. 20, 2007

(54) Wheel Rim Protector

(76) Inventor: Larry L. Lundy, Aurora, CO (US)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/424,096

(22) Filed: Jun. 14, 2006

(51) Int. Cl. B60B 7/01

(52) U.S. Cl. 301/37.24

(57) ABSTRACT

A wheel rim protector is described. Embodiments of the rim protector comprise a main component that provides wheel rim protection, and one or more clamping assemblies for affixing the rim protector to the wheel rim. The rim protector specifically protects the interface between the rim bead and the tire bead, and need not cover a large portion of the wheel rim or tire sidewall in order to be effective. Preferred embodiments of the rim protector are therefore relatively small and light weight, and are well suited for use on ATV wheels. Variations of the adjustable clamping assemblies in embodiments of the rim protector are well suited for use with wheels of various compositions, including, but not limited to, steel or aluminum alloys.

### FIELD OF THE INVENTION

The present invention relates generally to devices for protecting wheels or tires.

### BACKGROUND

Vehicle wheels are vulnerable to damage caused by impact with obstacles in the vehicle's path. Tubeless, pneumatic, vehicle wheels are susceptible to impact damage that compromises the pneumatic integrity of the interface between the rim bead and the tire bead, resulting in an interface that leaks air at a relatively rapid rate; a low or flat tire results.

All terrain vehicle (ATV) wheels are especially vulnerable to damage from impact with rocks, terrain features with relatively sharp edges, and other obstacles typically encountered during off-road travel. This special vulnerability arises from various factors, including, but not limited to, (1) the relatively low operating pressure of ATV tires, (2) the relatively small size of ATV wheels, and, (3) the demanding conditions of their typical use. Typical damage often includes deformation of the wheel rim bead or tire bead, or other damage, that compromises the integrity of the interface between the rim bead and the tire bead. A compromised interface often loses pneumatic integrity, resulting in loss of air, and a low or flat tire.

Wheel protectors and covers described in the prior art do not specifically protect the interface between a tire bead and rim bead, and consequently have features that are not well suited for such protection. Wheel protectors that protect a large portion of the tire or wheel rim are larger and heavier than need be for the specific purpose of protecting the integrity of the interface between the rim bead and the tire bead. The added weight of a wheel protector or cover can negatively affect vehicle performance, with larger, heavier wheel protectors or covers detracting more from performance than lighter protectors. Other prior art wheel protectors and covers fail to provide sufficient protection to the interface, and leave the interface vulnerable to impact damage.

### BRIEF DESCRIPTION OF THE DRAWINGS

FIG. 1 is an isometric, front view of a rim protector according to one embodiment of the present invention.

FIG. 2 is an isometric, front view of a rim protector mounted on a wheel rim, including a cut-away view of the wheel rim, according to one embodiment of the present invention.

FIG. 3 is an isometric, disassembled view of a clamping assembly according to one embodiment of the present invention.

FIG. 4 is an isometric, assembled view of a clamping assembly according to one embodiment of the present invention.

FIG. 5 is an isometric, partial view of a rim protector mounted on a wheel rim, including a cut-away, partial view of the wheel rim, according to one embodiment of the present invention.

FIG. 6 is an isometric, front view of a rim protector according to another embodiment of the present invention.

FIG. 7 is an isometric, front view of a rim protector mounted on a wheel rim, including a cut-away view of the wheel rim, according to another embodiment of the present invention.

FIG. 8 is an isometric, disassembled view of a clamping assembly according to another embodiment of the present invention.

FIG. 9 is an isometric, assembled view of a clamping assembly according to another embodiment of the present invention.

FIG. 10 is an isometric, partial view of a rim protector mounted on a wheel rim, including a cut-away, partial view of the wheel rim, according to another embodiment of the present invention.

### DETAILED DESCRIPTION

Embodiments of the present invention include wheel rim protectors that affix to wheel rims. The rim protectors are typically comprised of a substantially planar main component that has (i) a substantially planar front surface, (ii) a back surface, (iii) a substantially circular outside edge, and (iv) an inside edge that circumscribes an aperture. In some embodiments of the rim protector, the main components form annular plates wherein the apertures are substantially circular. The rim protectors typically further comprise one or more clamping assemblies adapted to affix the rim protectors to the rim of a wheel.

Typically, the clamping assembly is comprised of (i) a support block, (ii) a threaded clamping screw that extends through a threaded adjustment port in the support block, and (iii) a clamp attached to the clamping screw. The support block and the clamp are thus coupled via the clamping screw. A distance between the support block and the clamping screw is determined by a portion of the clamping screw that extends through the support block. The distance is adjusted by screwing the clamping screw farther in, or backing the clamping screw farther out, of the support block. Typical embodiments of the clamp include, but are not limited to, a hook, or a toe block.

The rim protectors are typically comprised of metals such as steel or aluminum alloys. Typical embodiments of the main component comprise alloys such as, but not limited to, 5052 and 6061 aluminum alloys. Materials such as polymers, copolymers, composites, and other dimensionally stable materials are also contemplated. The rim protector main component is typically substantially rigid. Embodiments of the rim protector main component that are preferably, but not necessarily, 0.1 in.-0.8 in. thick, are contemplated. Some embodiments of the rim protector, and particularly the main component, are substantially covered with a coating. Coating materials include, but are not limited to, polymers, copolymers, plastics, plastisol, thermoplastics, rubber, or synthetic rubber. Embodiments of the coating serve decorative, protective, or other functions.

Embodiments of the present invention shield a rim bead that interfaces with a tire bead of an associated tire, from damage caused by physical trauma. The trauma typically occurs from impact with rocks, terrain features with relatively sharp edges, and other obstacles typically encountered during off-road travel, wherein a wheel rim strikes the obstacle proximate to the rim bead with such force that the rim bead or the integrity of the interface with the tire bead is damaged or otherwise compromised. A flat tire typically results from such trauma. The wheel rim typically has inner and outer rim beads, and the tire typically has corresponding inner and outer tire beads. Accordingly, embodiments of the rim protector attach to, and therefore shield, either or both of the rim beads.

Typically, the rim protector extends beyond the rim bead, radially, both inwardly and outwardly. The protector therefore overlaps the tire sidewall to some degree. However, that overlap need not extend over most of the tire sidewall in order to effectively protect the associated rim bead or its interface with the tire bead. Indeed, one embodiment contemplated extends outwardly only about 0.2 in. beyond the outer circumferential edge of the rim bead, and therefore overlaps the tire by only about 0.2 in.

Embodiments of the rim protector are designed primarily to protect and shield a rim bead and the interface with a tire bead, and therefore need not extend far beyond the edge of a wheel rim. Accordingly, the embodiments are smaller than wheel covers and wheel protectors described in the prior art that are typically designed to protect one or both of the tire and the substantial entirety of the wheel rim. The present invention may therefore be smaller and lighter than other wheel covers and wheel protectors. One of ordinary skill in the art would appreciate that minimizing wheel weight is a performance consideration; un-sprung weight (vehicle weight that is not supported by the vehicle suspension) can be especially detrimental to vehicle performance. Moreover, wheel mass that is distributed farther out from the wheel center takes more force to accelerate or decelerate than wheel mass near the center. A rim protector of smaller outside diameter would therefore take less engine power to accelerate, and require less braking power to decelerate. Accordingly, the smaller outside diameter rim protectors contemplated herein would not detract from vehicle performance as much as larger diameter devices described in the prior art.

### Terminology

The terms and phrases as indicated in quotation marks (“ ”) in this section are intended to have the meaning ascribed to them in this Terminology section, applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning “either or both”.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and the appended claims refers to either an indirect or direct connection between the identified elements, components or objects. Often the manner of the coupling will be related specifically to the manner in which the two coupled elements interact.

The term “elliptical” means in the shape of an ellipse. An ellipse is a closed plane curve resulting from the intersection of a circular cone and a plane cutting completely through the cone. A circle is an ellipse wherein the plane is perpendicular to the axis of the circular cone; all points on the circle are equidistant from a fixed point, the center of the circle.

The term “affixed” means connected with, either directly or indirectly, such that the positions of affixed elements, components, or objects, relative to each other, are either permanently or temporarily fixed.

The term “support block” refers to a substantially solid block of material in which bores, slots, or other features may be formed; the bores may be threaded or not.

The term “wheel” refers to an assembly comprising a tire mounted on a rim. In a typical embodiment, the synthetic rubber tire mounts to the metal rim, forming a substantially airtight seal at the tire to rim interface. Other variations include, but are not limited to, embodiments that use an inner tube that eliminates the requirement for an airtight seal at the interface, as well as embodiments that use a non-pneumatic tire.

The term “wheel rim” refers to a cylindrical component, typically made of metal alloy, on which a tire mounts to form a wheel. A typical embodiment of the wheel rim comprises two rim beads, at or near the outer edges of the wheel rim, one at each end of the cylinder. A typical rim bead engages a tire bead to secure the tire to the wheel rim.

The term “rim bead” refers to a section of a wheel rim located at each end of the substantially cylindrical shape formed by the wheel rim. The rim bead typically comprises a sharply curved lip or other configuration adapted to engage a tire bead, and thereby secure the tire to the wheel rim. A typical embodiment includes a rim bead that forms a substantially airtight interface with the tire bead. However, some variations form a non-airtight interface.

The term “toe block” refers to a type of clamp with one end of the toe block shaped to engage a groove formed by the lip of a rim bead, by pressing into the groove. A typical toe block shape comprises a tapered, blunt terminus. A toe block type of clamp does not necessarily pinch the rim bead between two clamp members.

The term “ATV” refers to an all terrain vehicle. Such vehicles are typically motorized, single passenger, open-topped buggies with four wheels, though models with 3, 6, or 8 wheels exist. ATV embodiments are typically designed for off-road use. ATV wheels adapted to off-road use typically have relatively smaller diameters and lower pressure tires that make the wheel rims relatively more susceptible to damage from impact with rocks and other obstacles, than higher pressure tires typically used on other vehicles such as passenger cars and trucks.

Though some ATV tires have operating pressures as high as 25 pounds per square inch (psi), many ATV tires have operating pressures as low as 4-6 psi. Low pressure tires typically provide less protection against physical trauma to the wheel rims than higher pressure tires.

### A First Embodiment Rim Protector

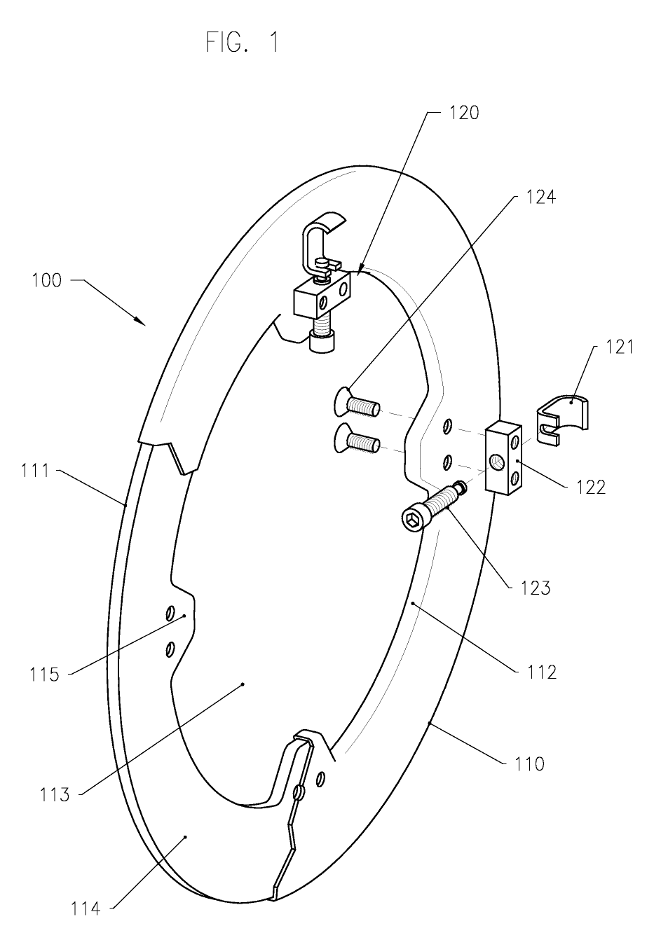

A first embodiment rim protector 100 is illustrated in FIG. 1. The first embodiment rim protector comprises a substantially planar main component 110 and one or more clamping assemblies 120. The main component comprises a substantially circular outside edge 111, an inside edge 112 that circumscribes an aperture 113, a front surface 114, and a back surface (not visible). The inside edge in this embodiment is substantially elliptical, circumscribing a substantially elliptical aperture, with one or more protrusions 115 that are typically integral with the main component, the protrusions interrupting the substantially elliptical shape of the inside edge. The one or more protrusions are formed by the main component protruding into the substantially elliptical perimeter of the aperture, and typically provide support for the one or more clamping assemblies. The substantially elliptical edge, shape, aperture, and perimeter of the first embodiment rim protector are substantially circular, a circle being a particular type of ellipse. Variations of the main component are also contemplated wherein the protrusions are not present. The front surface of the first embodiment is substantially planar and faces the wheel when mounted; the one or more clamping assemblies are affixed to the front surface. The back surface (not shown) of the first embodiment is substantially planar and faces away from the wheel when mounted. Other variations are also contemplated wherein the main component has a non-planar back surface. The shape of the non-planar back surface includes, but is not limited to, a rounded or convex shape.

The one or more clamping assemblies 120 of the first embodiment rim protector 100 are comprised of a hook 121, a support block 122, and a clamping screw 123. The hook is a specific type of clamp. The clamping assemblies of this embodiment are affixed to the main component 110 with one or more threaded fasteners 124. The first embodiment rim protector comprises four (4) clamping assemblies. Other variations of the rim protector are also contemplated wherein the number of clamping assemblies is less than four or greater than four, and wherein the clamping assemblies are attached to the main component by means such as, but not limited to, welding, riveting, and adhesive bonding. Some embodiments of the rim protector use, in addition to the one or more clamping assemblies, other means of attaching the rim protector to the wheel rim. The other means include, but are not limited to, fixed, non-adjustable structures that engage the wheel rim.

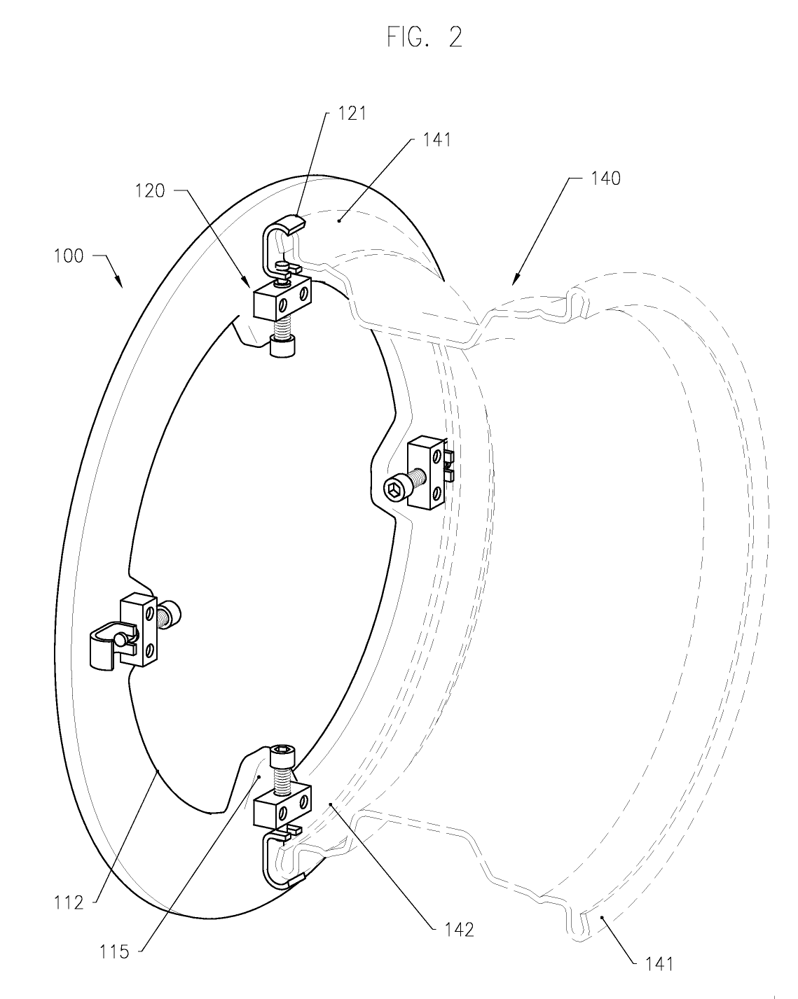

FIG. 2 illustrates the first embodiment rim protector 100 affixed to a wheel rim 140. The first embodiment rim protector attaches to, and therefore shields, either or both of the two rim beads 141 of a typical wheel rim. Two rim protectors can be used on a wheel rim to protect both of the rim beads. The hook style of clamp 121 in this embodiment typically affixes the rim protector to an aluminum alloy wheel rim. The distance the inside edge 112 of the main component (not including the protrusions 115, if present) extends radially inwardly from the outer edge 142 of the rim bead, is preferably, but not necessarily, 0.1 in.-3.0 in., more preferably, but not necessarily, 0.5 in.-1.5 in., and most preferably, but not necessarily, 0.9 in.-1.1 in. The distance the main component extends radially outwardly from the outer edge of the rim bead is preferably, but not necessarily, 0.2-4.0 in., more preferably, but not necessarily, 0.3 in-1.3 in., and most preferably, but not necessarily, 0.6 in.-0.9 in.

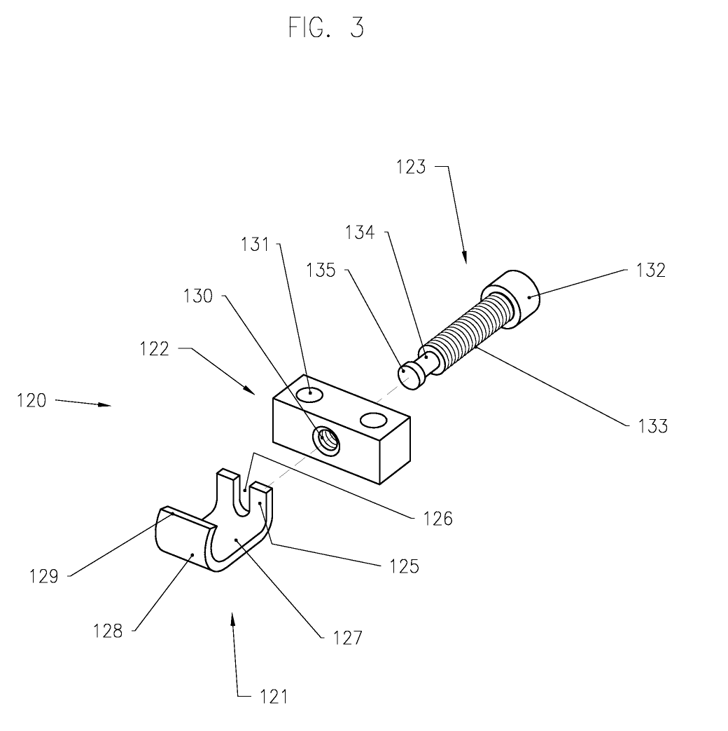

FIG. 3 illustrates the clamping assembly 120 of the first embodiment rim protector, wherein the style of clamp is a hook 121. The hook is comprised of a base 125, a slot 126, a shank 127, a bend 128, and a tip 129. The clamping screw 123 is comprised of a head 132, a threaded body 133, a neck 134, and a flange 135. The outside diameter of the clamping screw neck is smaller than the width of the slot in the hook; the neck therefore fits into the slot, the clamping screw thereby engaging the hook. The flange and the threaded body of the clamping screw both have diameters that are larger than the width of the slot in the hook; neither the flange nor the threaded body may therefore fit into, or pass through, the slot. The support block 122 is comprised of an adjustment bore 130 and a one or more fixation bores 131. The adjustment bore of the first embodiment rim protector clamping assembly is sized and threaded to engage the threaded body of the clamping screw in a manner familiar to one of ordinary skill in the art. Other variations have adjustment bores that are not threaded, the bores being larger than the threaded bodies of their respective clamping screws; these variations have other means for engaging the threaded body of the clamping screw that would be familiar to one of ordinary skill in the art, given the disclosure provided here. These other various means include, but are not limited to, threaded nuts adjacent to, or embedded in, the support block, that engage the threaded body of the clamping screw.

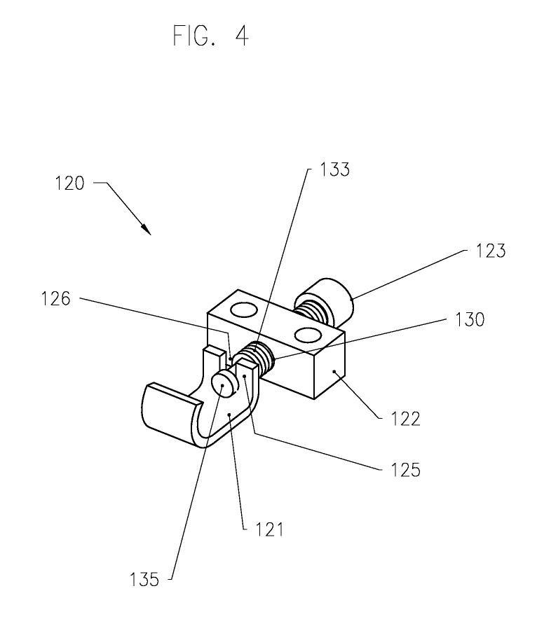

FIG. 4 illustrates the clamping assembly 120 in a typical configuration, wherein the clamping screw 123 engages the slot 126 of the hook 121. A distance that separates the hook from the support block 122 is thus modified by rotating the clamping screw in the support block, screwing the clamping screw in or backing it out, in a manner familiar to one of ordinary skill in the art.

The distance between the hook 121 and the support block 122 is increased by screwing the clamping screw 123 into the support block, so that the portion of the clamping screw that extends through the adjustment bore 130, and out the opposite side of the support block, is increased. Accordingly, the threaded body 133 of the clamping screw, which is too large to fit in the slot 134 of the hook, presses against the external surface of the base 125 of the hook and pushes the hook away from the support block. The neck 134 of the clamping screw turns substantially freely within the slot under these circumstances.

The distance between the hook 121 and the support block 122 is decreased by backing the clamping screw 123 out of the support block, so the portion of the clamping screw that extends through the adjustment bore 130 and out the opposite side of the support block, is decreased. Accordingly, the flange 135 of the clamping screw, which is too large to fit in the slot 134 of the hook, presses against the internal surface of the base 125 of the hook, so that the clamping screw pulls the hook toward the support block. The neck 134 of the clamping screw turns substantially freely within the slot under these circumstances.

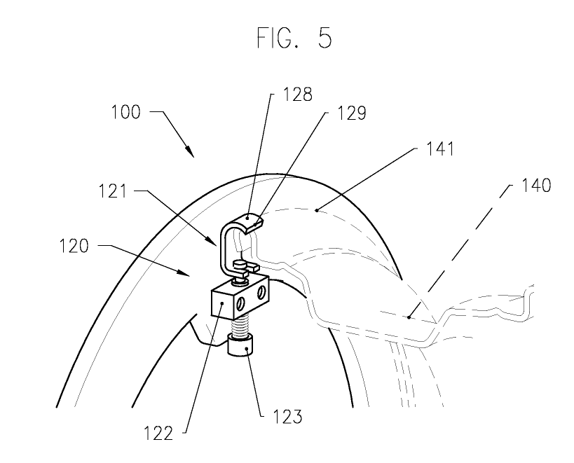

FIG. 5 illustrates in detail how the clamping assembly 120 engages the wheel rim 140 to affix the rim protector 100 in place. The rim protector is assembled so that if the rim protector is substantially in place on the wheel, the tip 129 of the hook 121 passes over the wheel rim bead 141 if the distance between the support block 122 and the hook is adjusted at or near its maximum. Where the clamping screw 123 is rotated relative to the support block to draw the hook toward the support block, the distance is thus reduced until the inside surface of the bend 128 presses against the rim bead with sufficient force to affix the rim protector to the wheel rim. As just described, the hook is held against the rim bead by tension between the support block, the clamping screw, and the hook. The hook can not readily disengage from the wheel rim because the tip of the hook is located radially inward of the rim bead outer curved surface, and therefore can not move radially outward unless the clamping screw is loosened sufficiently. Accordingly, the tip further secures the hook (and hence the rim protector) to the wheel rim by providing resistance to force that would pull the rim protector away from the wheel along an axis substantially perpendicular to the radial direction of the wheel.

### A Second Embodiment Rim Protector

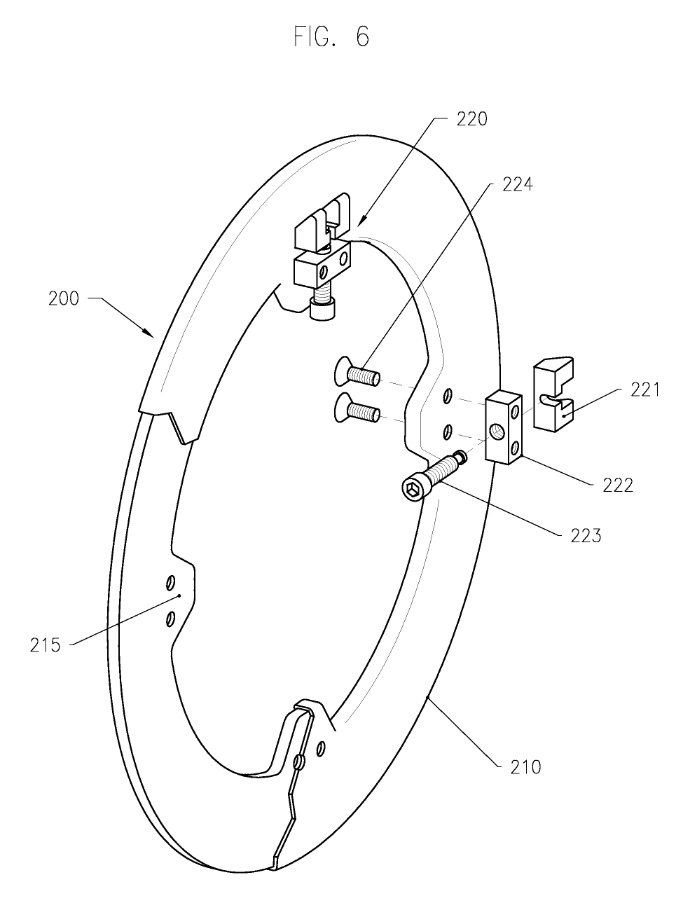

A second embodiment rim protector 200 is illustrated in FIG. 6. The second embodiment rim protector comprises a substantially planar main component 210 that is substantially similar to the first embodiment main component. The parts of the second embodiment rim protector are numbered in a manner analogous to the first embodiment rim protector, the first digit being a 2 instead of a 1, and the second and third digits being identical to the those of the analogous first embodiment part. For example, the substantially planar main component of the second embodiment rim protector is reference number 210, whereas the substantially planar main component of the first embodiment rim protector is reference number 110.

The second embodiment rim protector 200 further comprises one or more clamping assemblies 220. The one or more clamping assemblies of the second embodiment are affixed to the main component 210 at the positions of the one or more protrusions 215, and are comprised of a toe block 221, a support block 222, and a clamping screw 223. The toe block is a specific type of clamp. The clamping assemblies of this embodiment are affixed to the main component with one or more threaded fasteners 224. The second embodiment rim protector comprises four (4) clamping assemblies. Other variations of the rim protector are also contemplated wherein the number of clamping assemblies is less than four or greater than four, and wherein the clamping assemblies are attached to the main component by means such as, but not limited to, welding, riveting, and adhesive bonding. Some embodiments of the rim protector use, in addition to the one or more clamping assemblies, other means of attaching the rim protector to the wheel rim. The other means include, but are not limited to, fixed, non-adjustable structures that engage the wheel rim.

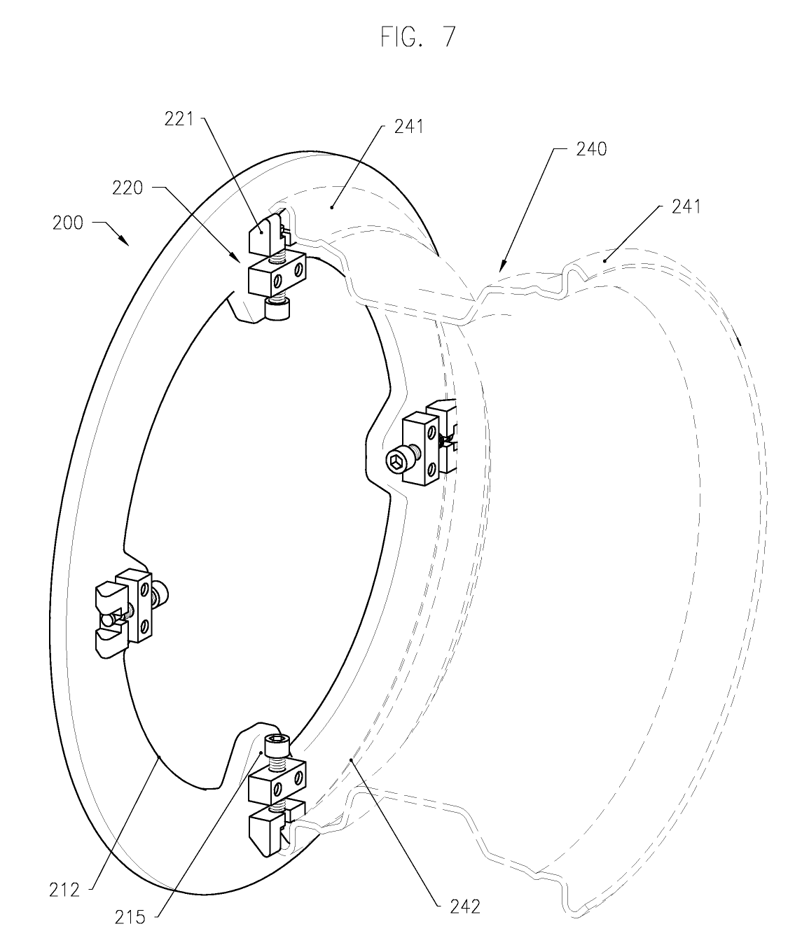

FIG. 7 illustrates the second embodiment rim protector 200 affixed to a wheel rim 240. The second embodiment rim protector attaches to, and therefore shields, either or both of the two rim beads 241 of a typical wheel rim. The toe block style of clamp 221 in this embodiment typically affixes the rim protector to a steel wheel rim. The distance the inside edge 212 of the main component (not including the protrusions 215, if present) extends radially inwardly from the outer edge 242 of the rim bead is preferably, but not necessarily, 0.1 in.-3.0 in., more preferably, but not necessarily, 0.5 in.-1.5 in., and most preferably, but not necessarily, 0.9 in.-1.1 in. The distance the main component extends radially outwardly from the outer edge of the rim bead is preferably, but not necessarily, 0.2-4.0 in., more preferably, but not necessarily, 0.3 in-1.3 in., and most preferably, but not necessarily, 0.6 in.-0.9 in.

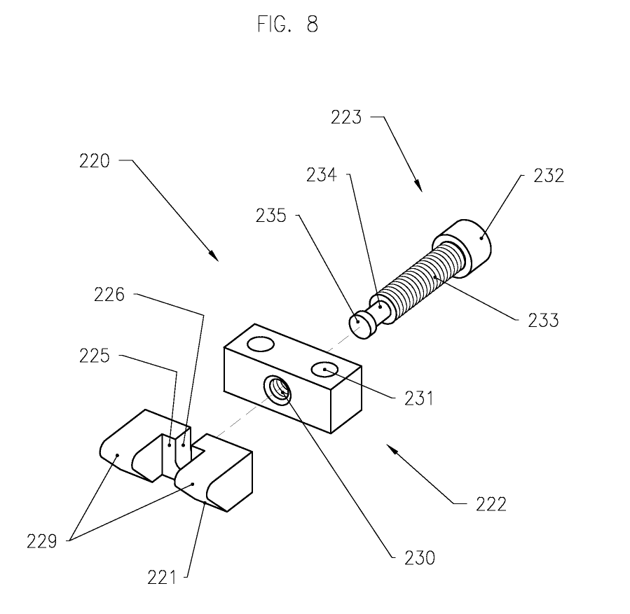

FIG. 8 illustrates the clamping assembly 220 of the second embodiment rim protector, wherein the style of clamp is a toe block 221. The toe block is typically comprised of a base 225, a slot 226, and two horns 229. The clamping screw 223 is comprised of a head 232, a threaded body 233, a neck 234, and a flange 235. The outside diameter of the clamping screw neck is smaller than the width of the slot in the toe block; the neck therefore readily slides into the slot. The flange and the threaded body both have diameters that are larger than the slot width; neither the flange nor the threaded body may therefore fit into, or pass through, the slot. The support block 222 is comprised of an adjustment bore 230 and a one or more fixation bores 231. The adjustment bore of the second embodiment rim protector clamping assembly is sized and threaded to engage the threaded body of the clamping screw in a manner familiar to one of ordinary skill in the art. Other variations have adjustment bores that are not threaded, and are larger than the threaded bodies of their respective clamping screws; these variations have other means for engaging the threaded body of the clamping screw that would be familiar to one of ordinary skill in the art, given the disclosure provided here. These other various means include, but are not limited to, threaded nuts adjacent to, or embedded in, the support block, that engage the threaded body of the clamping screw.

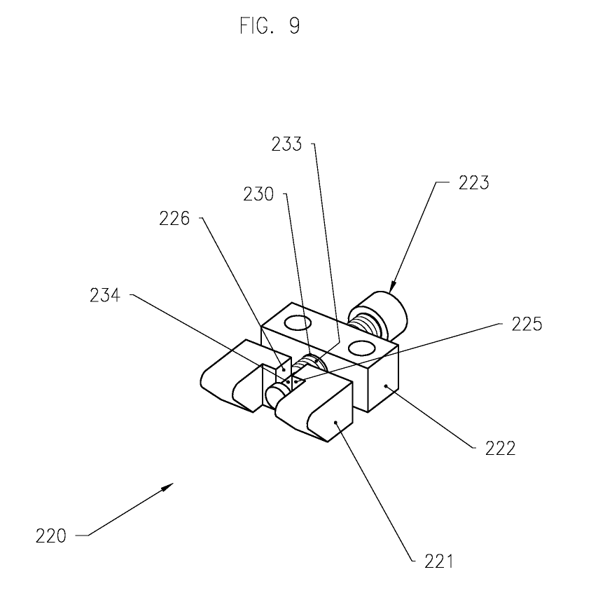

FIG. 9 illustrates the clamping assembly 220 in a typical configuration, wherein the neck 234 of the clamping screw 223 engages the slot 226 of the toe block 221. A distance that separates the toe block from the support block 222 is thus modified by rotating the clamping screw in the support block, screwing the clamping screw in or backing it out, in a manner familiar to one of ordinary skill in the art.

The distance between the toe block 221 and the support block 222 is increased by screwing the clamping screw 223 into the support block, so that the portion of the clamping screw that extends through the adjustment bore 230, and out the opposite side of the support block, is increased. Accordingly, the threaded body 233 of the clamping screw, which is too large to fit in the slot 226 of the toe block, presses against the external surface of the base 225 of the toe block and pushes the toe block away from the support block. The neck 234 of the clamping screw turns substantially freely within the slot under these circumstances.

The distance between the toe block 221 and the support block 222 is increased by screwing the clamping screw 223 into the support block, so the portion of the clamping screw that extends through the adjustment bore 230 and out the opposite side of the support block, is increased. Accordingly, the threaded body 233 of the clamping screw, which is too large to fit in the slot 234 of the toe block, presses against the external surface of the base 225 of the toe block, so that the clamping screw pushes the toe block away from the support block. The neck 234 of the clamping screw turns substantially freely within the slot under these circumstances.

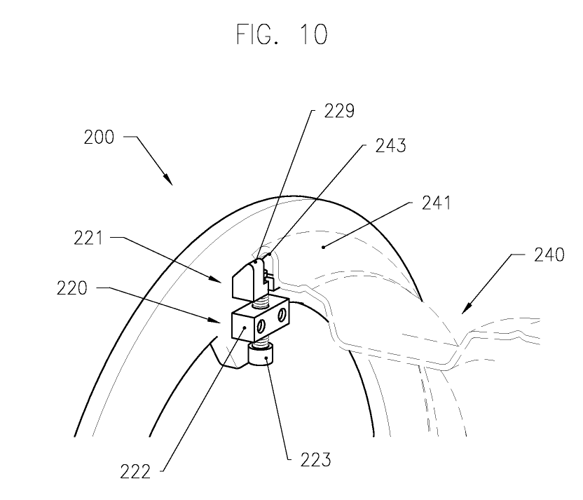

FIG. 10 illustrates in detail how the clamping assembly 220 engages the wheel to affix the rim protector 200 in place on the wheel rim 240. The rim protector is assembled so that if the rim protector is substantially in place on the wheel, the horns 229 of the toe block 221 fit inside the groove 243 formed by the rim bead 241, if the distance between the support block 222 and the toe block 221 is adjusted at or near its minimum. Where the clamping screw 223 is rotated relative to the support block to push the toe block away from the support block, the toe block is pressed into the groove and against the rim bead with sufficient force to affix the rim protector to the wheel rim. As just described, the toe block is held against the rim bead by compression between the support block, the clamping screw, and the toe block. The toe block can not disengage from the wheel rim because the horns, which are located radially outward of the rim bead's edge, can not move radially inward unless the clamping screw is rotated to pull the toe block toward the support block. Accordingly, the horns further secure the toe block (and hence the rim protector) to the wheel rim by providing resistance to force that would pull the rim protector away from the wheel along an axis substantially perpendicular to the radial direction of the wheel.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

For instance, embodiments of rim protectors are contemplated for use protecting the wheel rims of many types of wheeled vehicles in addition to ATV's. Such vehicles include, but are not limited to, passenger cars, trucks, off-road vehicles, both on and off-road racing vehicles, motorcycles, bicycles, and other motorized and non-motorized vehicles.

I claim:

1. A wheel rim protector comprising:
a substantially planar main component, the main component including (i) a front surface, (ii) a back surface, (iii) an inside edge, wherein the inside edge circumscribes an aperture, and, (iv) an outside edge, wherein the outside edge is substantially circular, a diameter of the outside edge adapted to be greater than a diameter of a wheel rim; and
one or more clamping assemblies adapted to affix the main component to the wheel rim, wherein the one or more clamping assemblies comprises:
a support block affixed to the main component; and
a clamping screw; and
a clamp adapted to engage the wheel rim, wherein:
the clamp is coupled to the support block by the clamping screw; and
the clamp engages the rim bead by use of compressive or tensile force applied to the clamp by an action of the clamping screw against the support block.

2. The wheel rim protector of claim 1, wherein the inside edge is substantially elliptical.

3. The wheel rim protector of claim 1, wherein the main component is substantially covered by a plastic coating.

4. The wheel rim protector of claim 1, wherein the support block is affixed to the main component by one or more threaded fasteners.

5. The wheel rim protector of claim 1, wherein:
the clamp of the one or more clamping assemblies is a hook adapted to engage the wheel rim by hooking over the edge of the rim bead; and
the clamping screw of the one or more clamping assemblies is adapted to apply a force to the hook, the force comprising either, (i) pushing the hook away from the support block, or, (ii) pulling the hook toward the support block; and
the hook is adapted to pull securely against the outside edge of the rim bead, the pulling force being applied to the hook by the clamping screw.

6. The wheel rim protector of claim 1, wherein:
the clamp in the one or more clamping assemblies is a toe block adapted to engage the wheel rim by pressing against the rim bead; and
the clamping screw of the one or more clamping assemblies is adapted to apply a force to the toe block, the force comprising either, (i) pushing the toe block away from the support block, or, (ii) pulling the toe block toward the support block; and
the toe block is adapted to push securely into the groove formed by the rim bead, the pushing force being applied to the toe block by the clamping screw.

7. A wheel assembly including, (1) a wheel rim, (2) a tire, and, (3) one or two wheel rim protectors of claim 2 mounted on the wheel rim, wherein:
the inside edge of the main component is substantially circular; and
a radius of the inside edge of the main component is 0.1 in.-3.0 in. less than the radius of the wheel rim; and
a radius of the outside edge of the main component is 0.2 in.-4.0 in. greater than the radius of the wheel rim.

8. A wheel assembly including, (1) a wheel rim, (2) a tire, and, (3) one or two wheel rim protectors of claim 2 mounted on the wheel rim, wherein:
the inside edge of the main component is substantially circular; and
the radius of the inside edge of the main component is 0.5 in.-1.5 in. less than the radius of the wheel rim; and
the radius of the outside edge of the main component is 0.3 in.-1.3 in. greater than the radius of the wheel rim.

9. A wheel assembly including, (1) a wheel rim, (2) a tire, and, (3) one or two wheel rim protectors of claim 2 mounted on the wheel rim, wherein:
the inside edge of the main component is substantially circular; and
the radius of the inside edge of the main component is 0.9 in.-1.1 in. less than the radius of the wheel rim; and
the radius of the outside edge of the main component is 0.6 in.-0.9 in. greater than the radius of the wheel rim.

10. The wheel assembly of claim 9, wherein:
the substantially circular shape of the inside edge of the main component is interrupted by protrusions of the main component, the protrusions being integral to the main component; and
the clamping assemblies affix to the main component at the positions of the protrusions.

11. The wheel assembly of claim 10, wherein:
the one or more clamping assemblies is three or more.

12. The wheel assembly of claim 11, wherein:
the clamp in the one or more clamping assemblies is a hook engaging the wheel rim by hooking over the edge of the rim bead; and
the clamping screw of the one or more of the clamping assemblies applies a force to the hook, the force comprising either, (i) pushing the hook away from the support block, or, (ii) pulling the hook toward the support block; and
the hook is pulled securely against the outside edge of the rim bead, the pulling force being applied to the hook by the clamping screw.

13. The wheel assembly of claim 11, wherein:
the clamp in the one or more clamping assemblies is a toe block engaging the wheel rim by pressing against the lip of the rim bead; and
the clamping screw of the one or more clamping assemblies applies a force to the toe block, the force comprising either, (i) pushing the toe block away from the support block, or, (ii) pulling the toe block toward the support block; and
the toe block is pushed securely into the groove formed by the rim bead, the pushing force being applied to the toe block by the clamping screw.

14. An ATV with one or more wheel assemblies of claim 12, the wheels having diameters of 12 in. or less.

15. An ATV with one or more wheel assemblies of claim 13, the wheels having a diameter of 12 in. or less.

16. A wheel assembly including, (1) a wheel rim, (2) a tire, and, (3) one or two wheel rim protectors, wherein the wheel rim protectors comprise;
a substantially annular plate, the annular plate including (i) an outside edge, wherein an outside diameter of the outside edge of the plate is greater than a diameter of the wheel rim bead, and, (ii) a substantially circular aperture circumscribed by an inside edge, wherein an inside diameter of the inside edge of the plate is less than the diameter of the wheel rim bead; and
one or more clamping assemblies affixing the plate to the wheel rim.

17. The wheel assembly of claim 16; wherein:
the outside edge of the plate extends away from the center of the wheel 0.3 in.-1.3 in. beyond the wheel rim; and
the inside edge of the plate extends toward the center of the wheel 0.5 in-1.5 in. inside the wheel rim; and

18. The wheel rim assembly of claim 16, wherein:
the outside edge of the plate extends away from the center of the wheel 0.6 in.-0.9 in. beyond the wheel rim; and
the inside edge of the plate extends toward the center of the wheel 0.8 in-1.2 in. inside the wheel rim.

19. An ATV comprising one or more wheel assemblies, the one or more wheel assemblies comprising a wheel rim, a tire, and one or two wheel rim protectors, wherein the rim protector comprises:
I. a substantially planar main component, the main component including (i) a front surface, (ii) a back surface, (iii) an inside edge, and, (iv) an outside edge, wherein:
A. the inside edge circumscribes a substantially circular aperture; and
B. the outside edge is substantially circular; and
C. the radius of the substantially circular inside edge of the main component is 0.9 in.-1.1 in. less than the radius of the wheel rim; and
D. the radius of the outside edge of the main component is 0.6 in.-0.9 in. greater than the radius of the wheel rim; and
E. the substantially circular shape of the inside edge of the main component is interrupted by protrusions of the main component at the positions of the clamping assemblies, the protrusions being integral to the main component; and
II. one or more clamping assemblies affixing the main component to the wheel rim, the one or more clamping assemblies comprising:
A. a support block affixed to the main component with one or more threaded fasteners; and
B. a clamping screw; and
C. a toe block, wherein
1. the toe block is coupled to the support block by the clamping screw; and
2. the clamping screw applies a force to the toe block, the force comprising either, (i) pushing the toe block away from the support block, or, (ii) pulling the toe block toward the support block; and
3. the toe block is pressed securely into a groove of the rim bead, the pushing force being applied by the clamping screw.

20. The ATV of claim 19, wherein the one or more clamping assemblies is three or more.
